(19) United States
(12) Patent Application Publication
(10) Pub. No.: US 2006/0159167 A1
(43) Pub. Date: Jul. 20, 2006

(54) Video decoding method and device for inverse quantization and zigzag scan

(76) Inventor: Wang Jiunn Shyang, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/136,503

(22) Filed: May 25, 2005

(30) Foreign Application Priority Data
Jan. 20, 2005 (TW) 094101682

(51) Int. Cl. H04N 11/04; H04N 11/02; H04B 1/66; H04N 7/12

(52) U.S. Cl. 375/240.03; 375/240.25; 375/240.23; 375/240.2

(57) ABSTRACT

A video decoding device and method for an inverse quantization and zigzag scan, which includes a receive unit having a counter for receiving at least one pixel and accumulating a counter value as an index of the pixel, and a process unit for retrieving a quantization parameter and a storing address of the pixel according to the index and further for obtaining an inverse quantization value of the pixel and the storing address of the inverse quantization value.

### BACKGROUND OF THE INVENTION

1. Field of Invention

The present invention relates to a video decoding device and method for inverse quantization and zigzag scan and, in particular, to a device and method which counts pixel as index for retrieving the quantization parameter and the storing address of the pixel, and hence for obtaining the inverse quantization value according the quantization parameter and storing the inverse quantization value to the storing address.

2. Related Art

For the reason of the digital technology progression and the higher integration tendency to audio and video signal, the digital recorder and related video decoding technique becomes essential to the digital recording device development. Conventionally, a decoding system includes a VLD (variable length decoder) for transforms an inputted compressed video signal to several fixed-length data block having 8 by 8 pixels, an inverse quantization unit connected to the VLD for retrieving the quantization parameter of each pixel according to individual characteristic of the pixel such that the quantization loss during encode stage may be compensated through calculating the corresponding inverse quantization value with the pixel, an inverse zigzag scan unit connected to the inverse quantization unit for obtaining the storing address of each pixel of the data block in a zigzag scan way and storing the pixels to a zigzag buffer sequentially according the storing address mentioned above, and an inverse discrete cosine transform unit for transforming the pixels of zigzag buffer and outputting frames to a display.

In general, the transmission way of pixels of data block in the conventional decoding system is raw by raw, whereas the inverse quantization unit and the inverse zigzag scan unit in a zigzag-scan way and process pixels in the data block size each time, which results in the delay and the video quality goes down in the inverse quantization and the inverse zigzag scan stages since the inverse quantization unit and the inverse zigzag scan unit waiting for the VLD to output all pixels of the data block. In addition, the extra storage for temporarily storing the pixels outputted by the VLD increases the decoding cost.

As mentioned above, the conventional decoding system is uneconomic in the aspects of both the time consumption and the extra storage allocation, and thus a video decoding device and method for combine the inverse quantization with the zigzag scan is necessary and pressing for digital video decoding technique improvement.

### SUMMARY OF THE INVENTION

In view of the foregoing, the invention is to provide a video decoding method for inverse quantization and zigzag scan, which includes the steps of receiving pixel and accumulating a counter value as an index of the pixel, then retrieving a quantization parameter and a storing address of the pixel according the index, obtaining an inverse quantization value according the quantization parameter, and storing the inverse quantization value to the storing address.

In addition, the invention further provides a video decoding device for inverse quantization and zigzag scan, which includes a receive unit for receiving pixel and accumulating a counter value as an index of the pixel, and a process unit for retrieving a quantization parameter and a storing address of the pixel according the index for further obtaining an inverse quantization value of the pixel and the storing address of the inverse quantization value.

Accordingly, the video decoding device and method for inverse quantization and zigzag scan of the present invention count pixel as index for retrieving the quantization parameter and the storing address of the pixel, and hence for obtaining the inverse quantization value according the quantization parameter without resulting in the delay and the video quality goes down in the inverse quantization and the inverse zigzag scan stages, and extra storage consumption and allocation for temporarily storing the outputted pixels.

### BRIEF DESCRIPTION OF THE DRAWINGS

The invention will become more fully understood from the detailed description given herein below illustration only, and thus is not limitative of the present invention, and wherein:

FIG. 1 is a block diagram showing a video decoding device for inverse quantization and zigzag scan according to a preferred embodiment of the invention;

FIG. 2 is a flow chart showing a video decoding method for inverse quantization and zigzag scan according to a preferred embodiment of the invention;

FIG. 3 is a block diagram showing a video decoding device for inverse quantization and zigzag scan according to another preferred embodiment of the invention;

FIG. 4 is a flow chart showing a video decoding method for inverse quantization and zigzag scan according to another preferred embodiment of the invention;

### DETAILED DESCRIPTION OF THE INVENTION

The present invention will be apparent from the following detailed description, which proceeds with reference to the accompanying drawings, wherein the same references relate to the same elements.

As mentioned above, the present invention is to provide a video decoding device and method for inverse quantization and zigzag scan as a solution of the decode delay and storage consumption problem which result from the processing data size restriction of the inverse quantization and inverse zigzag scan.

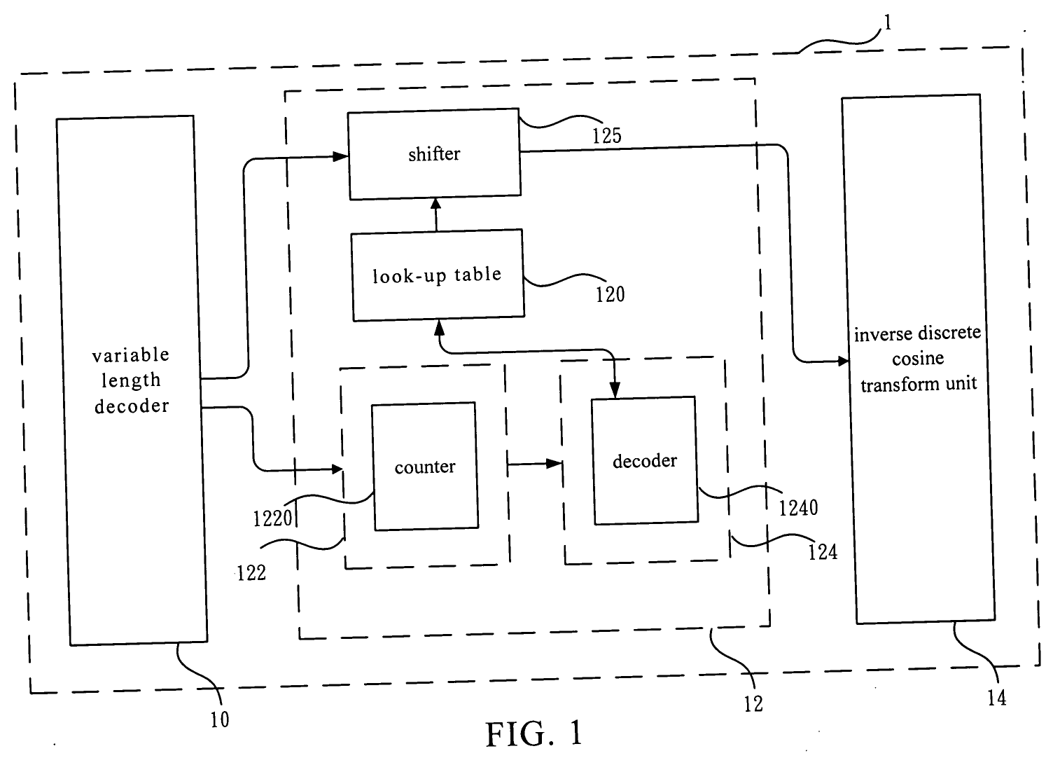

With reference to FIG. 1, a block diagram showing a video decoding device for inverse quantization and zigzag scan has a combination module of the inverse quantization unit with zigzag scan unit for retrieving the quantization parameter and the storing address of the pixel according the index. In this embodiment, the video decoding device 1 includes a variable length decoder 10, an inverse quantization and zigzag scan module 12, and an inverse discrete cosine transform unit 14. Herein, the quantization and zigzag scan module 12 includes a look-up table 120 which stores several quantization parameters and storing address, a receive unit 122 which includes a counter 1220 for accumulating the counter value while receiving the pixels, and a process unit 124 which includes a decoder 1240 for decoding and comparing the index with several addresses of the look-up table 120 and retrieving the quantization parameter and the storing address of the pixel, and a shifter 125 substituting for a multiplier which shifts the pixel according to the quantization parameter for obtaining and storing the pixel's inverse quantization parameter to a zigzag buffer for an inverse discrete cosine transform unit 14 to transform and output to a display.

In practice, the look-up table 120 mentioned above is substantially a random access memory for storing the quantization parameter and storing address. Assume that the look-up table 120 stores the quantization parameter and storing address of pixels of the first raw sequentially, the counter 1220 accumulates the counter value by 1 and takes it as the index of the first pixel when the receive unit 122 received the first pixel. Hence, the process unit 124 decodes and compares the index with several addresses of the look-up table 120 to retrieve the quantization parameter and the storing address of the pixel.

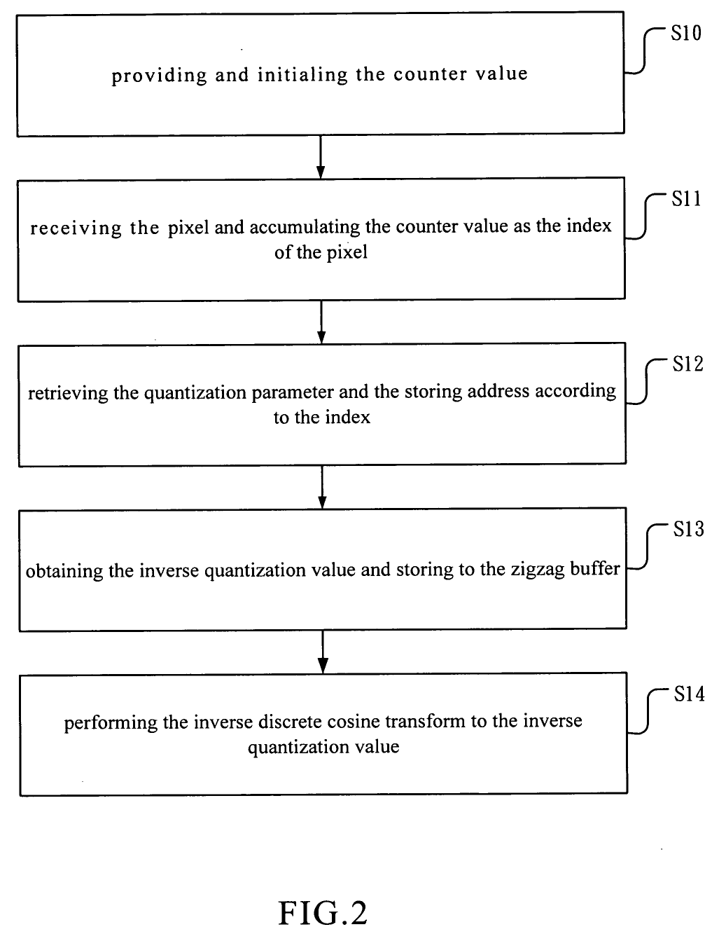

With reference to FIG. 2, suppose the pixels of the first raw includes the first to the eighth pixel in the embodiment, and the video decoding method for inverse quantization and zigzag scan of the invention includes the steps of: providing and initialing the counter value by zero in step S10, receiving the first pixel and accumulating the counter value by 1 as the index of the pixel in step S11, retrieving the corresponding quantization parameter such as “DC” and the storing address su as “1” of the first pixel by comparing the index “1” with the addresses of the look-up table 120 in step S12, obtaining the corresponding inverse quantization value according the quantization parameter and then storing the inverse quantization value to the corresponding storing address “1” of the zigzag buffer in step S13, and performing the inverse discrete cosine transform to the inverse quantization value and outputting corresponding frame of the first pixel to a display in step S14.

Moreover, the steps S11 to S14 performs repeatedly for each pixel, the corresponding quantization parameter such as “0,0,1, . . . 1” and the storing address such as “2,6,7, . . . 29” for the second to the eighth pixel respectively in the embodiment, and thus the real time inverse quantization process and rapid storing of the inverse quantization value to the zigzag buffer may be achieved without delay, image quality drop, and extra storage allocation and cost for temporarily storing the outputted pixels.

In addition, the look-up table 120 may be implemented through an index form which includes an index field, a quantization parameter field for storing the quantization parameter, and the storing address field for storing the storing address of each raw sequentially in the embodiment. Therefore, the process unit 124 may compare the index of pixel with that of the index field, and then retrieve the quantization parameter and the storing address of the index form when the index of pixel equals to that of the index field.

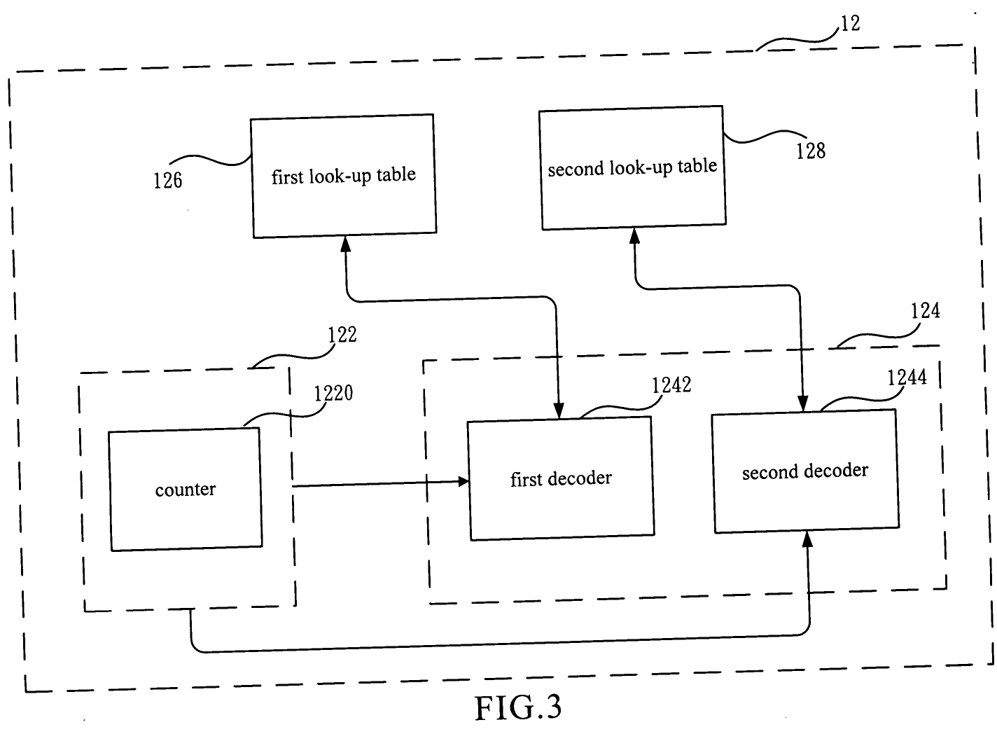

With reference to FIG. 3, the block diagram showing the video decoding device according to another preferred embodiment of the invention includes a first look-up table 126 for storing the quantization parameters and a second look-up table 128 for storing the storing addresses of the inverse quantization values. In addition, the process unit 124 further includes a first decoder 1242 for decoding and comparing the index with the addresses of the first look-up table 126 and retrieving the quantization parameter and the inverse quantization value, and a second decoder 1244 for decoding and comparing the index with the addresses of the second look-up table 128, retrieving the storing address of the second look-up table 128, and storing the inverse quantization value to the storing address of the zigzag buffer.

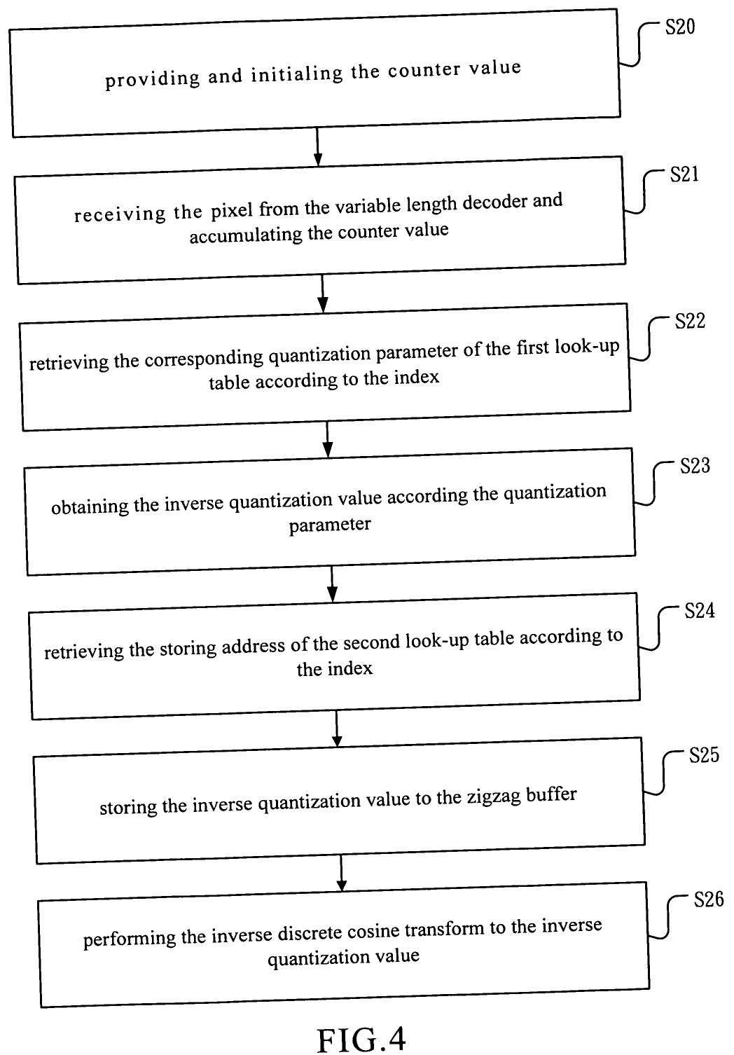

In addition, with reference to FIG. 4, the video decoding method according to another preferred embodiment of the invention includes the steps of: providing and initialing the counter value by zero in step S20, receiving the first pixel from the variable length decoder and accumulating the counter value by 1 as the index of the pixel in step S21, retrieving the corresponding quantization parameter such as “DC” by comparing the index with the storing addresses of the first look-up table in step S22, obtaining the corresponding inverse quantization value according the quantization parameter in step S23, comparing the index with the storing addresses of the second look-up table and obtaining the storing address such as “1” of the first pixel in step S24, storing the inverse quantization value to the storing address “1” of the zigzag buffer in step S25, and performing the inverse discrete cosine transform to the inverse quantization value and outputting corresponding frame of the first pixel to a display in step S26. It's noted that the processes for the third to the eighth pixel may be deduced by analogy.

As mentioned above, the video decoding device and method for an inverse quantization and zigzag scan of the present invention includes the receive unit having the counter for receiving pixels and accumulating the counter value as the index of these pixel, and the process unit for retrieving the quantization parameter and the storing address of the pixel according to the index and further for obtaining the inverse quantization value of the pixel and the storing address of the inverse quantization value. Therefore, the condition of taking the block size as the process unit during the inverse quantization and the inverse zigzag scan is not required anymore.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A video decoding method for inverse quantization and zigzag scan, comprising:
receiving at least one pixel and accumulating a counter value as an index of the pixel;
retrieving a quantization parameter and a storing address of the pixel according the index; and
obtaining an inverse quantization value according the quantization parameter and storing the inverse quantization value to the storing address.

2. The method of claim 1, further comprising:
providing and initialing the counter value before receiving at least one pixel.

3. The method of claim 1, wherein the quantization parameter and the storing address stores in a look- up table.

4. The method of claim 3, further comprising:
decoding and comparing the index with a plurality of addresses of the look-up table, and retrieving the quantization parameter and the storing address while the index equals to one address of the look-up table.

5. The method of claim 1, wherein the quantization parameter and the storing address are stored in a first look-up table and a second look-up table respectively.

6. The method of claim 5, further comprising:
decoding and comparing the index with a plurality of addresses of the first look-up table, and retrieving the quantization parameter while the index equals to one address of the first look-up table; and
decoding and comparing the index with a plurality of addresses of the second look-up table, and retrieving the storing address while the index equals to one address of the second look-up table.

7. The method of claim 1, further comprising:
obtaining the inverse quantization value of the storing address for performing an inverse discrete cosine transform to the inverse quantization value.

8. A video decoding device for an inverse quantization and zigzag scan, comprising:
a receive unit, which receives at least one pixel and accumulates a counter value as an index of the pixel; and
a process unit, which retrieves a quantization parameter and a storing address of the pixel according the index for further obtaining an inverse quantization value of the pixel and the storing address of the inverse quantization value.

9. The device of claim 8, further comprising:
a variable length decoder, which provides the pixel.

10. The device of claim 8, further comprising:
a shifter, which shifts the pixel according to the quantization parameter.

11. The device of claim 8, wherein the receive unit further comprising:
a counter, which accumulates the counter value while receiving the pixel.

12. The device of claim 8, further comprising:
a look-up table, which stores the quantization parameter and the storing address.

13. The device of claim 12, wherein the process unit further comprising:
a decoder, which decodes and compares the index with a plurality of addresses of the look-up table and retrieving the quantization parameter and the storing address.

14. The device of claim 8, further comprising:
a first look-up table, which stores the quantization parameter; and
a second look-up table, which stores the storing address of the inverse quantization value.

15. The device of claim 14, wherein the process unit further comprising:
a first decoder, which decodes and compares the index with a plurality of addresses of the first look-up table, and retrieves the quantization parameter of the first look-up table corresponding to the index; and
a second decoder, which decodes and compares the index with a plurality of addresses of the second look-up table, and retrieving the storing address of the second look-up table corresponding to the index.

16. The device of claim 8, further comprising:
an inverse discrete cosine transform unit, which performs an inverse discrete cosine transform to the inverse quantization value.
